(19) United States
(12) Patent Application Publication
(10) Pub. No.: US 2007/0005657 A1
(43) Pub. Date: Jan. 4, 2007

(54) Methods and apparatus for processing XML updates as queries

(76) Inventors: Philip L. Bohannon, Bridgewater, NJ (US); Wenfei Fan, Somerset, NJ (US)

Correspondence Address: Ryan, Mason & Lewis, LLP, Suite 205, 1300 Post Road, Fairfield, CT, 06824, US

(21) Appl. No.: 11/171,129

(22) Filed: Jun. 30, 2005

(51) Int. Cl. G06F 17/30

(52) U.S. Cl. 707/200

(57) ABSTRACT

Methods and apparatus are provided for processing updates to an XML document. Updates are converted into one or more complement queries that can be performed on the XML document. The complement queries provided by the present invention allow (i) virtual views of XML data to be updated; (ii) updates and queries to be composed; and (iii) the XML document to be updated using an XML query engine. The XML document can be recursively processed to determine for each node whether the node is affected by the update and implementing the update at the affected nodes.

### FIELD OF THE INVENTION

The present invention relates to techniques for processing updates to XML data, and, more particularly, to methods and apparatus for processing updates to XML data as queries.

### BACKGROUND OF THE INVENTION

It is often desired to rewrite an update as a query that returns the same data as would be produced by performing the update in place. Among other reasons, this is needed to define a view in terms of updates while avoiding the destructive impact of the updates on the source data. For example, consider an exemplary XML document T₀ depicted in FIG. 1, that contains a list of parts. Each part has a pname (part name), a list of suppliers and a subpart hierarchy, and a supplier in turn has a sname (supplier name), a price (offered by the supplier), and a country (where the supplier is based).

A number of user groups may query the document T₀ simultaneously, each with a different access-control policy that prevents disclosure of price information from suppliers of certain countries. To enforce the access control, each group is provided with a: security view that returns a document containing all the data from T₀ that is not about the sensitive price information. These views should be virtual because it may be exceedingly costly to create and maintain a different (materialized) view for each user group. Unfortunately, such views are far from trivial to write by hand in, e.g., XQUERY, as the price information may appear at arbitrary depths in T₀. In contrast, it is conceptually straightforward to “delete” the price data in a view, perhaps with a simple statement such as “delete //supplier [country=‘c₁’ [symbol] . . . [symbol] country=‘cₙ’]/price. Note that the intention is not to delete this data in the source; instead, it is merely to define the security view of a client with the update syntax, which is in turn rewritten into an equivalent query. Then, user queries posed on the view can be answered by composing the queries and the view and evaluating the composed queries directly on the original T₀.

Another user may be concerned that a planned tariff will cause a 15% increase in the price of parts imported from a number of countries, and wants to find out the new costs of those parts affected by the changes. However, the user cannot update T₀ in place before the new tariff policy takes effect. One way to achieve this update is by creating a separate copy of T₀, updating the copy and then computing the costs by posing queries on the updated copy. A more efficient approach is to define a virtual view of T₀ in terms of the updates by rewriting the updates into a view query, and thus avoid copying the entire T₀. Then, one can compute the costs by composing queries with the view using the standard view querying methods, so that the composed queries can be evaluated against the original T₀.

Another set of users may pose queries and updates on T₀, while T₀ may itself be actually a virtual document defined through data integration. In this case, there may be no sensible notion of performing an update on the virtual data; but one could still obtain a new document that would result from such an update on the document. Again, translating the update into a query and performing query composition will produce the desired result.

While a number of techniques have been proposed or suggested for rewriting updates into queries for relational databases (cf., S. Abiteboul et al., Foundations of Databases, Ch. 1 (Addison-Wesley, 1995)), computing complement queries becomes challenging for XML due to the nested nature of XML documents. A need therefore exists for methods and apparatus for rewriting updates as an equivalent query on XML data. That is, given an update u that needs to be applied to an XML document T to produce T′, the update u is rewritten as a query Qᵤ^{c}, such that Qᵤ^{c}(T)=T′. Thus, a (virtual) view can be defined directly in terms of update syntax.

### SUMMARY OF THE INVENTION

Generally, methods and apparatus are provided for processing updates to an XML document. According to one aspect of the invention, updates are converted into one or more complement queries that can be performed on the XML document. The complement queries provided by the present invention allow (i) virtual views of XML data to be updated; (ii) updates and queries to be composed; and (iii) the XML document to be updated using an XML query engine. In one implementation, the XML document is recursively processed to determine for each node whether the node is affected by the update and implementing the update at the affected nodes.

A more complete understanding of the present invention, as well as further features and advantages of the present invention, will be obtained by reference to the following detailed description and drawings.

### BRIEF DESCRIPTION OF THE DRAWINGS

FIG. 1 illustrates an exemplary XML document, T₀;

FIG. 2 illustrates exemplary code for a complement query for an exemplary insert operation;

FIG. 3 illustrates exemplary pseudo-code for an exemplary restricted top down method incorporating features of the present invention;

FIG. 4 illustrates exemplary pseudo-code for an exemplary nextStates function incorporating features of the present invention;

FIG. 5 illustrates an example selecting non-deterministic finite state automata (NFA) of an X query;

FIG. 6 illustrates exemplary pseudo-code for an exemplary topDown function incorporating features of the present invention;

FIG. 7 illustrates exemplary pseudo-code for an exemplary qualDP function incorporating features of the present invention;

FIG. 8 illustrates an example filtering NFA of an X query;

FIG. 9 illustrates exemplary pseudo-code for an exemplary bottomUP function incorporating features of the present invention;

FIG. 10 illustrates exemplary code for a complement query for exemplary insert updates;

FIG. 11 illustrates exemplary code for a complement query for an exemplary sequence of updates;

FIG. 12 illustrates exemplary pseudo-code for an exemplary multiUpdate function incorporating features of the present invention;

FIG. 13 illustrates exemplary pseudo-code for an exemplary sweep function incorporating features of the present invention; and

FIG. 14 is a block diagram of a system 1400 that can implement the processes of the present invention.

### DETAILED DESCRIPTION

The present invention provides methods and apparatus for processing updates to XML data as queries on the data. According to one aspect of the invention, methods and apparatus are provided for rewriting of XML updates into queries. That is, given an update u over an XML document T, a query Qᵤ^{c}, referred to as a complement query of u, is derived such that Qᵤ^{c}(T) returns the same document as would be produced by updating T in place with u. Thus, one can define a (virtual) view in terms of updates while avoiding the destructive impact of updates. Furthermore, queries can be directly composed with updates. The need for this is evident in, e.g., XML security, integration and update testing. A number of alternative algorithms are provided for computing complement queries from a class of XML updates commonly found in practice. Algorithms are disclosed for computing a single complement query from a sequence of updates, based on incremental computation. Complement queries computed in accordance with the present invention can be evaluated in time linear in the size of the XML document.

Among other benefits, it is easier to define certain views with updates than writing directly in, e.g., XQUERY. More importantly, other queries can be composed with the update (in its query or view form) by leveraging query composition techniques. Qᵤ^{c} is referred to as a complement query of u.

According to another aspect of the invention, updates can be rewritten using a naive approach to rewriting a class of XML updates into complement queries in XQUERY. Defined in terms of XPATH, the disclosed update language is the core of many known update languages, and can express many updates commonly found in practice. The naive algorithm produces complement queries that are efficient when only a small fraction of the document is touched by u.

According to yet another aspect of the invention, a more optimized approach is presented for expressing Qᵤ^{c} in XQUERY. Generally, this top-down approach yields a query Qᵤ^{c} that processes u via a single top-down traversal of the input XML tree T, identifying the nodes to be updated based on a notion of selecting non-deterministic finite state automata (NFA) and a function checkp( ) that checks the satisfaction of XPATH qualifiers in u involved at each node encountered.

Another aspect of the invention provides a bottom-up technique for implementing checkp( ) of Qᵤ^{c} that evaluates all the XPATH qualifiers in u via a single bottom-up traversal of T, in case that the query processor does not handle complex qualifiers well. Thus, the evaluation of Qᵤ^{c} requires at most two passes of T: a bottom-up pass for evaluating qualifiers followed by a top-down pass for selecting nodes to be updated.

In addition, another aspect of the invention produces a complement query Q_{\vec{u}}^{c} for a sequence of updates \vec{u}=u₁, . . . , uₖ over a document T. This is required for, e.g., defining a view in terms of a sequence of updates, and it allows the cost of processing a complement query to be amortized over a sequence \vec{u} of updates. It is shown that the sequence \vec{u} of updates can be batched into a single complementary query Q_{\vec{u}}^{c} such that Q_{\vec{u}}^{c}(T)=uₖ( . . . (u₁(T) . . . ). An algorithm is also provided to compute Q_{\vec{u}}^{c} that handles \vec{u}based on incremental computation. Such a complement query combines the evaluation XPATH qualifiers in \vec{u} via a single pass of T. Then, while processing updates in \vec{u} one by one, for each update Q_{\vec{u}}^{c} only inspects qualifiers associated with the portion of data changed by previous updates in \vec{u}, instead of conducting two passes of the entire T for each update.

The disclosed techniques for rewriting XML updates into complement queries have several salient features. First, complement queries Qᵤ^{c} produced by the present invention (for a single update and a sequence of updates) have a linear-time data complexity that is the best one can expect since it is the lower bound for evaluating XPATH queries embedded in u alone. In addition, the algorithms accommodate referential transparency (side-effect free) of XQUERY and can be readily coded in XQUERY. Further, the disclosed techniques provide the ability to define (virtual) views in terms of updates and to compose queries with updates without side effects on the source data. In addition, the disclosed techniques suggest techniques potentially useful for implementing XML updates.

It is noted that complement queries are evaluated on top of an XML query processor at the source level, and thus it is unreasonable to expect that an implementation of updates via complement queries outperforms direct implementation of updates in an XML query processor. As a byproduct, however, the present invention yields a convenient approach to supporting XML update functionality when update support is not available on a particular platform. For XML data stored as a file in a file system, the lower bound of time required to update a document is linear in the size of the data (for uploading the data from and re-serializing out to the file system), which is comparable with the efficiency of complement queries produced by the present algorithms. Furthermore, translating updates to queries allows a uniform optimizer to be used for both queries and updates.

XML Updates

As the standard language for XML updates is not yet available, a class of updates is considered that is supported by most proposals for XML update languages. This class of updates is defined in terms of XPATH (J. Clark and S. DeRose, XML Path Language (XPath), W3C Working Draft (November 1999)).

1. XPath

The exemplary embodiments of the present invention use core XPATH (G. Gottlob et al., “Efficient Algorithms for Processing XPath Queries,” VLDB (2002)) with downward modality. This class of queries, referred to as X, is defined by:
p::=ε|l|*|p/p|p//p|p[q],
q::=p|p=‘s’|label( )=l|qˆq|q q|q,
where ε, l and * denote the empty path, a label (tag) and a wildcard, ‘u’, ‘/’ and ‘//’ stand for union, child-axis and descendant-or -self-axis, respectively; and q in p[q] is called a qualifier, in which s is a constant (string value), and ‘ˆ’, ‘ [symbol] ’ and ‘ [symbol] ” denote conjunction, disjunction and negation, respectively. For //, p₁/ //p₂ is abbreviated as p₁//p₂.

An XPATH query p is evaluated at a context node v in an XML tree T, and its result is the set of nodes of T reachable via p from v, denoted by v∥p∥.

2. XML Updates

With the class X of XPATH expressions, an XML update language is defined, denoted by U, using the syntax of P. Lehti, “Design and Implementation of a Data Manipulation Processor for an XML Query Processor,” Technical Report, Technical University of Darrnstadt, Diplomarbeit (2001). The language supports four operations:
insert const-expr into p
delete p
replace p with const-expr
rename p as s
   where p is an XPATH expressions in X, const-expr is a constant XML element (subtree), and s is a string value denoting a label. Similarly, U_{f} is the corresponding update language in which XPATH expressions are drawn from X_{f}.

Generally, given an XML tree T with root r, the insert operation finds all the elements reachable from r via p in T, and adds the new element e given by const-expr as the last child of each of those elements. More specifically, (1) it computes r∥p∥; (2) for each element v in r∥p∥, it adds a as the rightmost child of v.

Similarly, the delete operation first computes r∥p∥ and then removes all the nodes in r∥p∥ (along with their subtrees) from T. The replace operation computes r∥p∥ and then replaces each v in r∥p∥ with e defined by const-expr. Finally, the rename operation computes r∥p∥ and for each v in r∥p∥, changes the label of v to s. The new tree obtained by an update u is denoted as u(T).

Referring to the XML tree T₀ of FIG. 1, let e be a supplier element with name HP. Then, one can apply the following update operations of U to T₀:

(1) insert e into p₁, where p₁ is X expression //part[pname=‘keyboard’] //part[ [symbol] supplier/sname=‘HP’ ˆ [symbol] supplier/price<15]; this is to first find every keyboard in T₀, and then for each of its subparts that is supplied neither by HP nor at a price lower than $15 by any supplier, add e as a supplier;

(2) delete p₂, where p₂ is //part[pname=‘keyboard’]/subpart//supplier[ [symbol] sname=‘HP’ ˆ [symbol] price<15]; this is to remove from T₀ the suppliers of all subparts of any keyboard except for supplier HP and those suppliers selling at a price lower than $15;

(3) replace p₃ with e, where p₃ is //part[pname=‘keyboard’]/supplier[sname=‘Compaq’ ] this is to substitute e for the supplier Compaq of any keyboard;

(4) rename//country as address changes the label country to address for every country in T₀.

Each operation may incur multiple changes at an arbitrary depth of T₀, since the same part element may occur at different places of T₀, due to the subpart hierarchy.

Computing Complement Queries

Three techniques are presented that, given an XML update u in the language U, compute a query Qᵤ^{c} in XQUERY such that Qᵤ^{c}(T)=u(T) for any XML document T. Qᵤ^{c} is referred to as a complement query of u.

The first technique, referred to as the Naive Method, consists of a set of query templates in XQUERY. For an update u in U, one of these templates may be instantiated to form a complement query Qᵤ^{c}. These templates demonstrate the feasibility of finding complement queries for XML updates. This method, however, may not work well when the set of nodes changed by the update is large.

The second technique, referred to as the Top Down Method, uses recursive XQUERY functions, and simulates the evaluation of an automaton on the (paths of) the tree. Combined with optimization techniques to be introduced in the next section, complement queries produced by this method are guaranteed to take at most linear time in the size of the document.

1. Naive Method

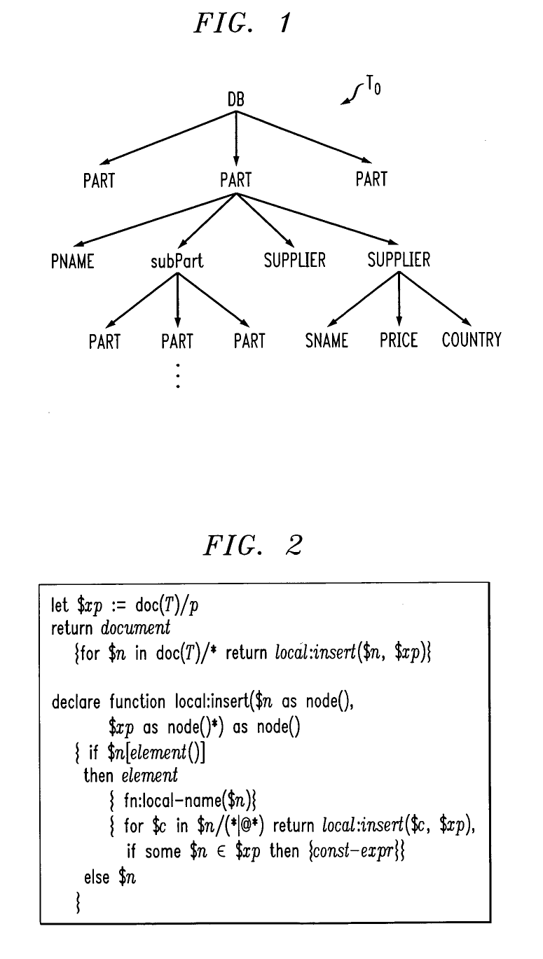

For any update u in U, one can construct a complement query Qᵤ^{c}. To illustrate this, consider u=insert const-expr into p over a document T, where const-expr evaluates to an XML element, and p is an XPATH query. The update u can be rewritten into Qᵤ^{c} in XQUERY, as shown in FIG. 2, following recursive-query transformations suggested by the XQUERY standard. Let r be the root of T. Generally, the query Qᵤ^{c} first evaluates the XPATH query p to compute r∥p∥, the set of nodes selected by p; then, it invokes a function insert. The insert function takes a node $n and r∥p∥ as input, and it processes $n as follows. If $n is an element, then it constructs an element that has the same label as that of $n and carries the children of $n; furthermore, if $n is in r∥p∥then it evaluates const-expr and adds it as the last child of $n. The function then recursively processes the children of $n in the same way. The node is returned without change if it is not an element. It is easy to see that Qᵤ^{c} (T) produces the same result as u(T). This yields a generic complete-query template for insert operations. Similarly one can rewrite delete, replace and rename into complement queries in XQUERY.

Since doc(T)/p and const-expr in this template can be instantiated with arbitrary XQUERY expressions (not just queries in X or constant expressions), it is shown that for a wide variety of updates one can find a complement query. However, these queries are inefficient when the scope of the update is broad (i.e., when p is not very selective and |$xp| is large): in the worst case it takes quadratic time in the size of T, i.e., in O(|T|²) time unless the XQUERY engine optimizes the test nε$xp.

2. Restricted Top Down Method

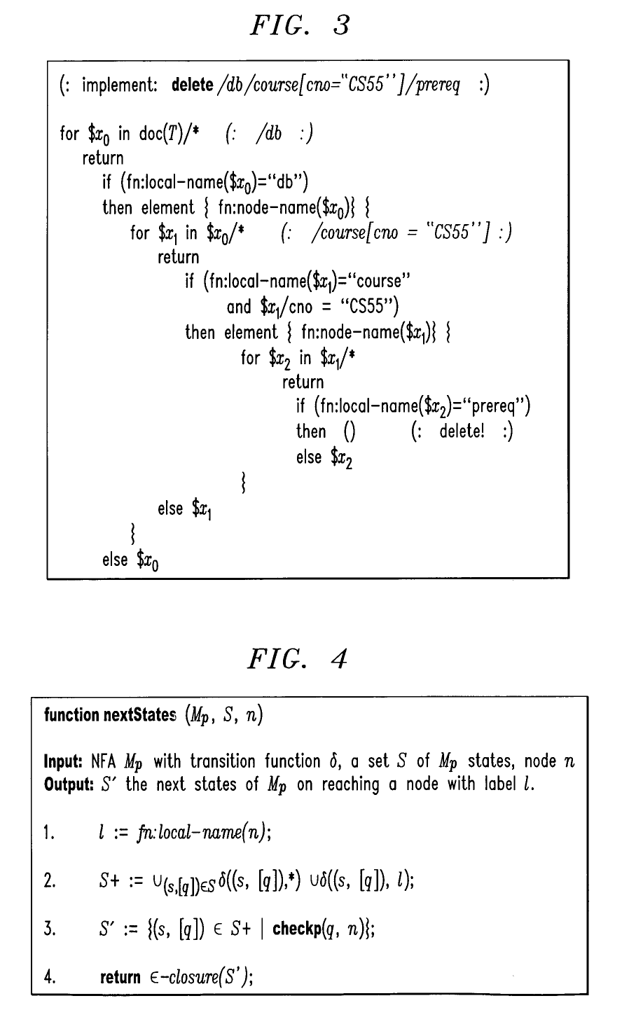

A Restricted Top-Down Method is shown in FIG. 3 that handles updates in U_{f}. Those updates can be rewritten into complement queries without using recursive XQUERY functions. Consider an update uεU_{f} (recall that XPATH expressions in U_{f} only include “//” in predicates). In this case, a non-recursive complement query Qᵤ^{c} can be (recursively) generated. Consider the update u=delete/db/course[cno=“CS55”}/prereq. FIG. 3 shows Qᵤ^{c} as generated by the restricted top-down method. This query is formed by, at the i'th level of the tree, returning subtrees that do not match step i in p, while recursively processing those that do. Once the final step of p is matched, an appropriate step is taken based on the form of the update. In the case of delete, nothing is returned thus “deleting” the subtree. The other cases (insert, replace and rename) are also simple, and are not shown due to lack of space.

3. General Top Down Method

The disclosed top-down method, given an update u, produces a complement query Qᵤ^{c} with linear asymptotic behavior, based on a notion of selecting NFA. Generally, for the X query p in u, the selecting NFA of p, denoted by Mₚ, is generated, which is a mild extension of NFA and is used for identifying nodes in r∥p∥. The query Qᵤ^{c} maintains a set S of (current) states in Mₚ as it traverses the XML tree T top-down. For each encountered node n in T, n's label is used to change S to S′ according to the function nextStates( ) shown in FIG. 4, described below. The action taken at the node depends on which of the following holds: (1) if S′ includes the final state of Mₚ, then n is selected by p and the appropriate update action is performed; (2) if S′ is empty, then no change is to be made to the subtree rooted at n and thus it can be simply returned; and (3) otherwise, n may be on a path to a node selected by p, and the top down traversal proceeds to the children of n.

A. Constructing Mₚ

The selecting NFA Mₚ of an X query p is defined as follows. Observe that p=β₁[q₁]/ . . . /βₖ[qₖ], where βᵢ is either label 1, wildcard * or descendant //. Mₚ=(K, Γ, δ, s, f), where (1) the set K of states consists of the start state s=(sₒ, [true]), and for each iε[1, k], a state (sᵢ, [qᵢ]) denoting the step βᵢ with the qualifier [qᵢ], where the final state f is(sₖ, [qₖ]); (2) the alphabet ν consists of all the labels in p and the special wildcard *; (3) the transition function δ is defined as follows: for each i in [0, k−1], δ((sᵢ, [qᵢ]), βᵢ₊₁)=(sᵢ₊₁, [qᵢ₊₁]) if βᵢ₊₁ is a label or *, and δ((sᵢ, [qᵢ]), ε)=(sᵢ₊₁, [qᵢ₊₁]) and δ((sᵢ, [qᵢ]),*)=(sᵢ, [qᵢ]) IF βᵢ₊₁ is //.

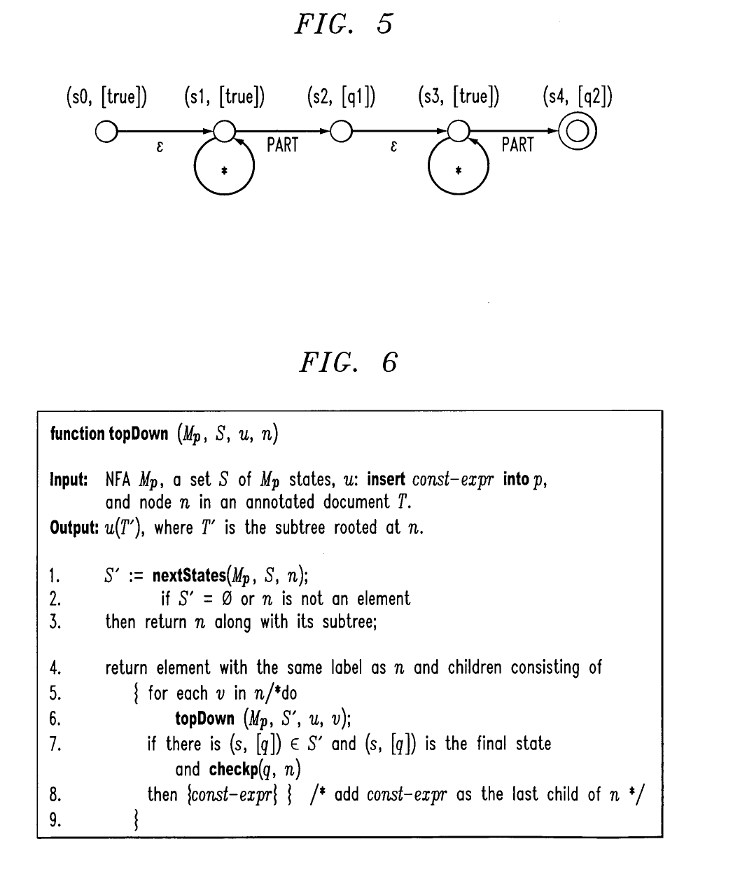

Recall the X query p₁ given above. The selecting NFA for p₁ is depicted in FIG. 5, where q₁ is [pname=‘keyboard’ ] and q₂ is [ [symbol] supplier/sname=‘HP’ˆ [symbol] supplier/price<15].

A selecting NFA Mₚ has the following notable features. First, Mₚ has a semi-linear structure: the only cycles in Mₚ are self-cycles labeled * and introduced by //. Note that from any state (sᵢ, [qᵢ]) at most two states can be reached via the δ function. Second, while Mₚ is based on the “selecting path” of p, it incorporates its qualifiers into the states, which, as discussed below, is effective in pruning unaffected subtrees. Third, Mₚ can be constructed in O(|p|²) time, and its size is bounded by O(|p|).

B. Next States

The function nextStates( ), shown in FIG. 4, handles state transitions in Mₚ when encountering a node n. For each state (s, [q]) in S, nextStates( ) computes the Mₚ states (s′, [q′]) reached from (s, [q]) by inspecting the label of n and the transition function δ of Mₚ (line 2); moreover, nextStates( ) checks whether the qualifier [q′] is satisfied at n by calling a predefined function checkp( ), where checkp(qᵢ, n) returns true iff ε[qᵢ] is non-empty at n.

Note that, to cope with the E transitions in the NFA Mₚ, the ε-closure of S′ must be computed (line 4), which is the set of all the states reachable from any state of S′ via one or more ε transitions in Mₚ. The ε-closure of S′ can be computed in O(|p|) time. Also, by the construction of selecting NFAs given earlier, if δ ((s, [q]), *) (or δ ((s, [q]), fn:local-name(n))) is defined, then it maps to a single state rather than a set. Thus, the cardinality of S′ when computed by repeated calls to nextStates( ) is bounded by O(|p|).

C. Top Down Method

The General Top Down Method is illustrated for an update u=insert const−expr into p. This is described by the algorithm topDown given in FIG. 6; the algorithms for delete, rename and replace are similar, as would be apparent to a person of ordinary skill in the art. The (recursive) algorithm takes as input an insert u, the selecting NFA Mₚ of p in u, a set S of current states in Mₚ, and a node n in an XML tree T. When called with n as the root of an XML tree T and S consisting of (the ε-closure of) the start state for Mₚ, topDown computes u(T). Given the set S that keeps track of the states reached after traversing T from the root to the parent of n, top Down computes S′ by using nextStates( ). If S′ is empty, then the subtree of n should not be changed, and thus it is simply copied to the result (lines 2-3). Otherwise, topDown recursively processes the children of n, taking S′ as a parameter (lines 5-6). Furthermore, if S′ includes the final state and its corresponding qualifier is satisfied, then const-expr is evaluated and inserted as the last child of a (lines 7-8).

Recall that u equals insert c into p₁ in the above example. Given the root of the XML tree T₀ of FIG. 1, the NFA of FIG. 5, the update u, and a set S consisting of the start state (Sₒ, [true]) of Mₚ and (s₁, [trite]), topDown adds supplier HP to every part whose states contain the final state s₄.

Observe the following about topDown. First, it can be readily realized in a way that incurs no side effects and thus yields a complement query Qᵤ^{c} in XQUERY. Second, if checkp( ) takes constant time, then for any update u on an XML tree T, Qᵤ^{c} takes at most O(|T∥p|) time, where p is the X query in u. That is, it takes time linear in |T|. A technique is presented to achieve this in the next section. Third, the use of selecting NFA allows us to simply return unchanged subtrees without further recursive processing.

Handling Expensive Qualifiers in One Pass

In this section, an algorithm, bottomUp, is presented that implements checkp( ) used in the TopDown method of the previous section. Taken together with algorithm topDown, algorithm bottomUp produces a complementary query Qᵤ^{c} for any uεU such that Qᵤ^{c}, is guaranteed to execute in time linear in the size of the document, including the cost of implementing checkp( ). This algorithm may be implemented inside an XQUERY processor, or in XQUERY itself in the spirit of the rewriting of topDown. Practically, if complex qualifiers are handled well by the processor, the bottomUp algorithm is not necessary. However, (1) not all processors handle complex qualifiers efficiently; (2) it is possible to use bottomUp for only those qualifiers that are known to be handled poorly; and (3) novel techniques will be introduced in the next section to efficiently handle sequences of updates, and these techniques extend bottom Up.

Generally, given an update u over an XML tree T, bottom Up evaluates all the qualifiers in the XPATH expression p in u via a single bottom-up traversal of T, and annotates nodes of T with the truth values of related qualifiers. Given the annotations, at each node checkp( ) takes constant time to check the satisfaction of a qualifier at the node. This exemplary implementation of checkp( ) is at the cost of executing bottomUp before topDown. BottomUp executes in linear time in |T|, and thus it does not increase the overall data complexity bound.

1. Evaluating Qualifiers

A. Qualifiers and Sub-Qualifiers

In the following algorithm, a list of qualifiers Q is processed that includes not only all the qualifiers appearing in p, but also all sub-expressions of these qualifiers. Furthermore, Q is topologically sorted such that for any expression e in Q, if s is a sub-expression of e, s appears before e in Q. To simplify the presentation, a “normalized” form of X qualifiers is adopted such that each path p in a qualifier is of the form ρ/p′ where ρ is one of *, // or ε[q], and p′ is a path. This normalization can be achieved by using the following rewriting rules: (1) l to */ε[label( )=l]; (2) p[q] to p/ε[q]; (3) p[q₁] . . . [qₙ] to p[q]where q=q₁ˆ . . . ˆqₙ; and (4)ₚ=‘s’ to p[ε=‘s’]. The normalization process takes at most O(|p|²)time.

For the X query p₁ given above, the list Q contains the expressions q₃=[ε=‘keyboard’], q₁=[pname[q₃]], q₆=[ε=‘HP’], q₅=[sname[q₆]], q₄=[sup plier[q₅]], q₉=[ε<15], q₈=[price[q₉]], q₇=[sup plier[q₈]] and q₂=[ [symbol] q₄ˆ [symbol] q₇]. Note that all expressions are in the normal form mentioned above, and sub-expressions appear before their containing expression.

B. Dynamic Programming

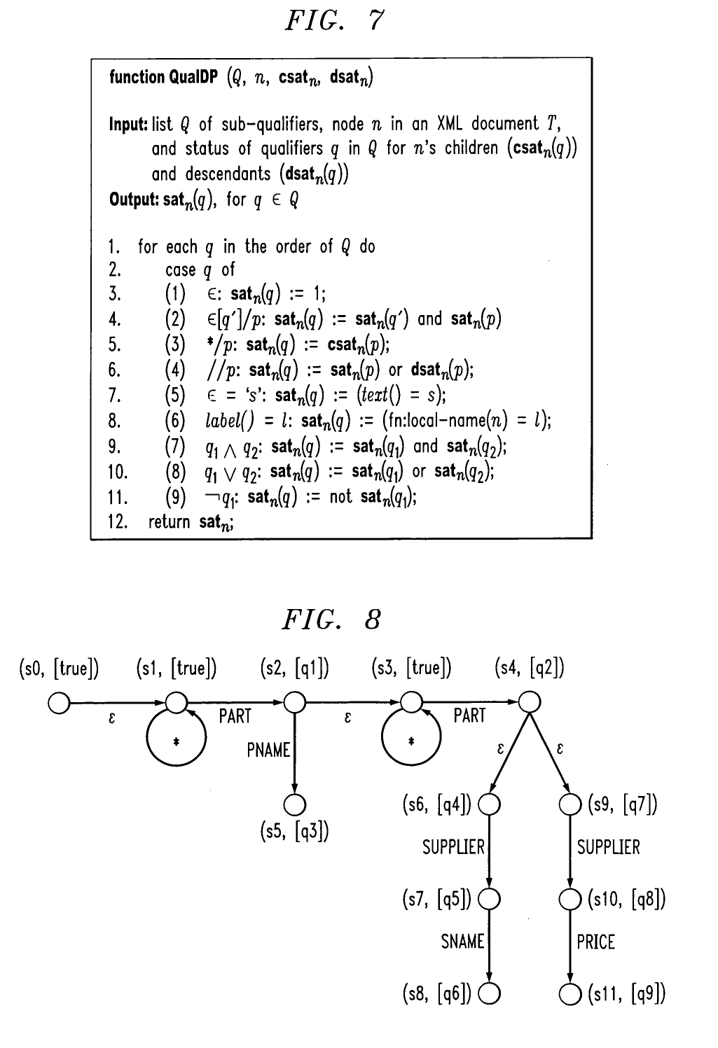

An important step of bottomUp is the evaluation of qualifiers. It is done based on dynamic programming, as follows. Assume that the truth values of all the qualifiers q in Q are already known for (1) the immediate children of n (denoted by csatₙ(q)), and (2) for all the descendants of n excluding n (csatₙ(q)). Then, in order to compute the satisfaction of the qualifiers at n, denoted by satₙ(q), it suffices to do a constant amount of work per qualifier, as summarized in function QualDP( ) in FIG. 7.

It is noted that care is needed for this recursion to work when computing satₙ (q) at the leaves n of the tree. To do this, csat ⊥ (q) (resp. dsat ⊥ (q)) is defined such that it is false when q ranges over expressions of the form */p; otherwise it is computed in the same way as in QualDP( ).

The truth values for all qualifiers in Q can be computed in time O(|Q|) at any node in a tree T.

C. Filtering NFA

Another important issue for bottom Up is to determine the list Q of qualifiers to be evaluated at each node of T. To do this, a notion of filtering NFA is introduced. Given an X expression p, a NFA is constructed, referred to as the filtering NFA of p and denoted by M_{f}, which is an extension of selecting NFAs used in top Down. Generally, M_{f} is built on both the selecting path and the qualifiers of p, stripping off the logical connectives in the qualifiers; the states of M_{f} are also annotated with corresponding qualifiers. M_{f} is used to keep track of whether a node n is possibly involved in the node selecting of p and what qualifiers are needed at n. Filtering automata are illustrated with the following example instead of giving its long yet simple definition (which is similar to its selecting NFA counterpart).

The filtering NFA for the query p₁ of the above example is depicted in FIG. 8.

For a set S of states of a filtering NFA M_{f}, Q(S) denotes the list of all qualifiers appearing in the states of S, along with their sub-expressions, properly ordered with sub-expressions preceding their containing expressions.

The size of the filtering NFA M_{f} for an X query p is in O(|p|), since only a constant amount of information needs to be stored about each expression (as in a parse tree).

2. Bottom Up Computation of Qualifiers

Another aspect of the invention provides an overall algorithm for computing qualifiers of an X expression p via a single bottom-up traversal of an XML tree T.

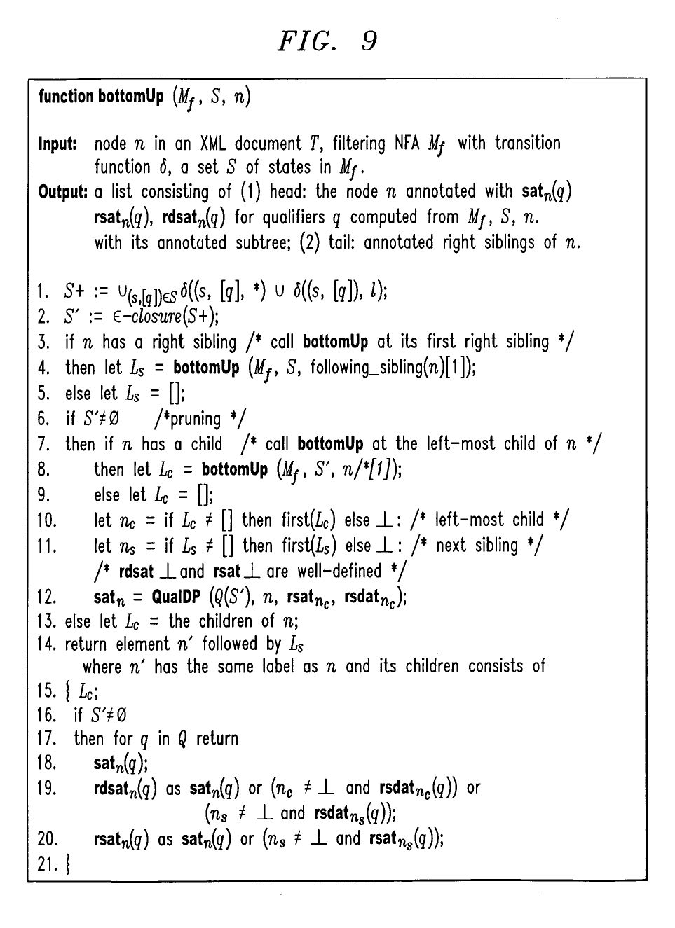

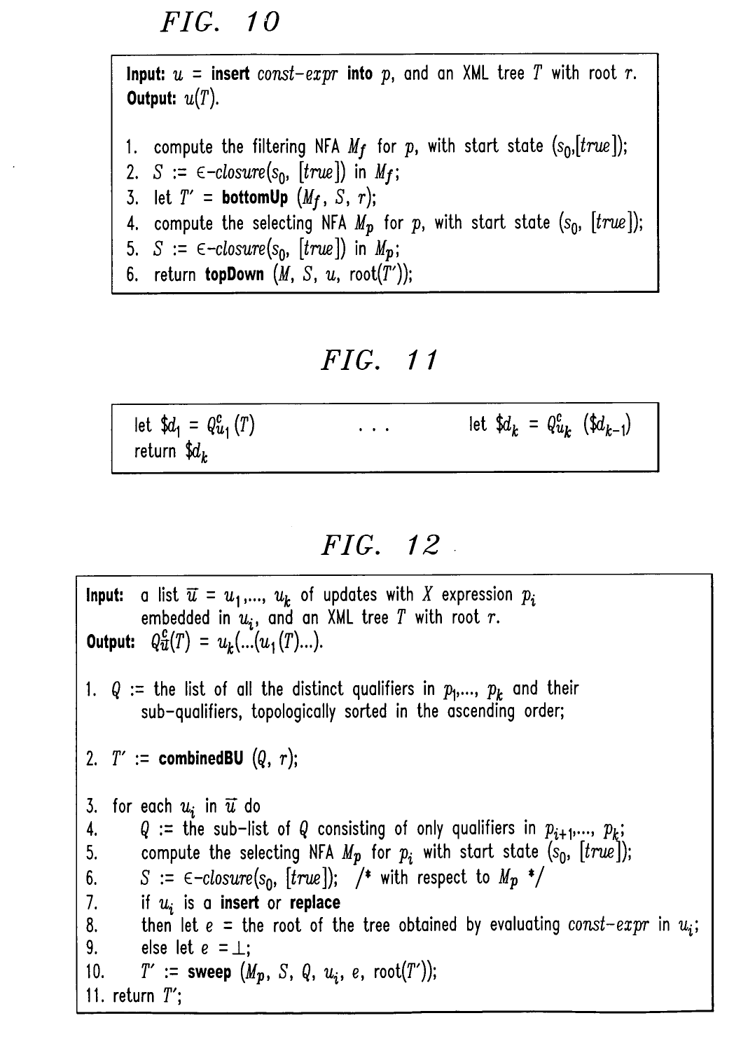

The algorithm, bottomUp, is shown in FIG. 9. The input of bottomUp consists of (1) a node n in T, (2) the filtering NFA M_{f} for p, and (3) a set S consisting of the M_{f} states reached after traversing T from the root to the parent of n. Using M_{f}, S and the label of n, the algorithm computes the new set of states S′ (in a manner similar to nextStates( ) but without calls to checkp( )). From these states, the qualifiers Q(S′) that need to be computed at n are derived and evaluated.

To compute satₙ(q) the algorithm associates two vectors of boolean values with n:
rsatₙ(q) holds if q is satisfied at n or at any right siblings of n (if any);
rdsatₙ(q) holds if q is satisfied at n, or at a descendant of n, or at a descendant of a right sibling of n.

These vectors have the following properties. Assume that n_{c}, and nₛ are the left-most child and the immediate right sibling of n, respectively. Then, for qεQ, rsatₙ_{_{c}}(q) is true if and only if there exists a child of n that satisfies q and thus rsatₙ_{_{c}}=csatₙ. Furthermore, rdsatₙ_{_{c}}(q) is true if and only if there exists a descendant of n at which q is satisfied, thus rdsatₙ_{_{c}}=dsatₙ. Observe that rsatₙ(q) and rdsatₙ(q) can be computed based on rsatₙ_{ₛ}(q), rdsatₙ_{_{c}}(q) and rdsatₙ_{ₛ}(q) by their definitions. Note that rsatₙ, and rdsatₙ, can be associated with n by adding an XML attribute for each vector with a sequence of “1” (true) or “0” (false).

Taken together, the algorithm bottomUp first computes the set S′ of M_{f} states reached from S by inspecting the label of n and the transition function δ of M_{f} (lines 1-2). These steps mirror nextStates( ), but omit the checking of qualifiers. Next, bottomUp calls itself recursively on its right sibling (line 3) and left-most child (line 8), which returns the children list L, and the list of right siblings Lₛ. It uses QualDP( ) to compute satₙ, (line 13). Finally, bottomUp returns a list (lines 14-21) with an element n′ as the head, which has the same label as n, carries children L_{c} and is annotated with satₙ, rsatₙ(q) and rdsatₙ(q); the tail of the list is the right-sibling list Lₛ.

In order to cope with the referential transparency (side-effect free) of XQUERY, the bottom-up traversal of the XML tree is simulated by recursively invoking bottom Up at the left-most child and the immediate right sibling of n, if any; in this way each node is visited at most once. Observe that the emptiness check of S′ (lines 6) allows avoiding recursively processing the subtrees that will contribute neither to the node-selecting path of p nor to the qualifiers needed in the node selecting decision. That is, only if S′ is not empty, bottomUp are invoked at the children of n and QualDP( ) is called.

The combined complexity of bottomUp is O(|T∥p|²) and its data complexity is linear in |T|. In practice, |p| is often small.

Consider again p₁ of the above example. Given the root of the document T₀ of FIG. 1, the filtering NFA of M_{f} in FIG. 8 and the ε-closure of the initial state of M_{f}, the algorithm bottomUp computes satₙ(q), rsatₙ(q) and rdsatₙ(q) for each node n in T₀ and its related qualifiers q, and returns T₀ annotated with boolean values. Note that, for example, only qualifiers [q₅], [q₆], [q₈] and [q₉] are evaluated at supplier elements, rather than the entire [q₁]-[q₉].

As another example, given p′=supplier//part and the root r of T₀, bottomUp returns T₀ right after checking the immediate children of r, since the filtering NFA for p′ reaches no state from r, which has no supplier children.

A. Combining bottomUp with topDown

Putting bottomUp and topDown together, provides a complement query for XML updates in U. For example, a complement query Qᵤ^{c} for insert operations u is shown in FIG. 10 (similarly for delete, replace and rename, as would be apparent to a person of ordinary skill in the art). Now checkp(q, n) in topDown simply checks satₙ(q) associated with node n, and thus takes constant time. Since the NFAs M_{f} and Mₚ can be computed in O(|p|) time, and topDown, bottomUp are in O(|T∥p|) and O(|T∥p|²) time, respectively, the data complexity of Qᵤ^{c} is linear-time in |T|.

B. Properties

The complement query Qᵤ^{c} has several salient features. First, it is optimal: the entire computation of Qᵤ^{c}(T) can be done with two passes of T, which are necessary for evaluating the embedded XPATH query p alone. Second, Qᵤ^{c} can be readily coded in XQUERY. Indeed, the list Q and the NFAs can be coded in XML, sat, rsat and rdsat can be treated as XML attributes, and assignment statements can be easily replaced with side-effect free function calls. BottomUp and topDown are recursive functions to simplify the discussion and to facilitate their encoding in XQUERY. Finally, as noted above, the overhead of bottomUp is not required for simple qualifiers. This can be easily accommodated by the present algorithm by using checkp( ) from the last section for qualifiers that can be determined efficiently in the native processor, and removing such qualifiers from p before computing M_{f} in line 1 of FIG. 10.

Alternatively, if integrated with an XQUERY processor, the computation of bottomUp can be combined with the loading of the document, and topDown can be integrated with the output of the new document. This also suggests an approach to implementing XML updates with two passes of the XML document in the entire computation.

C. Static Analysis of XML Updates

The analysis of XML updates at compile time might seem to speed up the performance. For example, given u=insert e into p, if the XPATH expression p is not satisfiable, then u can be simply rejected without being evaluated. This may help in certain simple cases, but unfortunately, not much in general. This is because it involves the satisfiability analysis of XPATH queries, i.e., the problem to determine, given an XPATH query p, whether or not there is any XML document T (with root r) such that r|p| is nonempty. The analysis is currently generally too expensive to be practical: it is EXPTIME-hard for X, and is already PSPACE-hard for a subset of X without “//” and disjunction.

Complement Query of Multiple Updates

The problem of processing a sequence of XML updates is now addressed: given \vec{u}=u₁, . . . , uₖ, where uᵢ is an update defined in U, the task is to find a single complementary query Q_{\vec{u}}^{c} such that Q_{\vec{u}}^{c}(T)=uₖ( . . . (u₁(T) . . . ) for any XML tree T. As observed above, this is important for defining a (virtual) XML view in terms of a sequence of updates, among other things. In response to this, it is shown that it is always possible to find such a Q_{\vec{u}}^{c} by presenting a naive Nested Query Method. Another method is then presented for computing more efficient Q_{\vec{u}}^{c} based on incremental computation techniques.

1. Nested Query Method

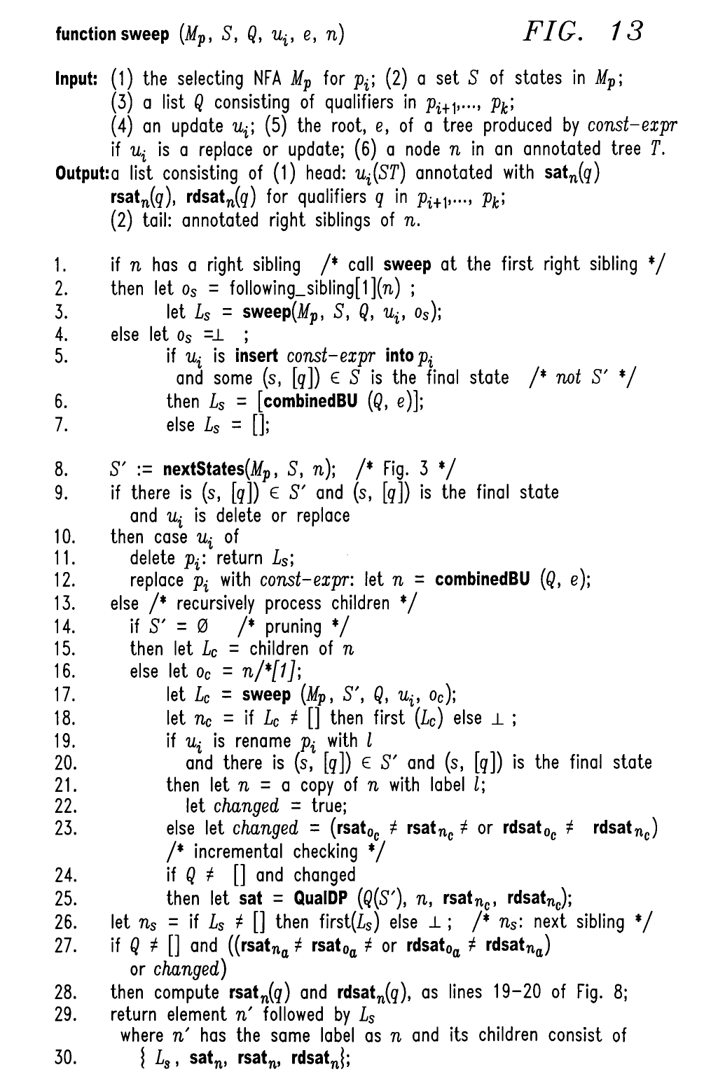

A single complementary query Q_{\vec{u}}^{c} can be computed for a sequence \vec{u}=u₁, . . . , uₖ of updates by leveraging the composability of XQUERY and the rewriting algorithms given in the last section, as follows: (1) compute a complement query Qᵤ_{ᵢ}^{c} for each uᵢ in \vec{u} and (2) compose Qᵤ_{ᵢ}^{c}'s into a single query Q_{\vec{u}}^{c}, as shown in FIG. 11, where T is the XML document on which \vec{u} is to be performed. This complemented query takes at most O(|u₁|²T₁|+ . . . +|uk|²|Tₖ∥) time, where T₁=T and Tᵢ=uᵢ₋₁(Tᵢ₋₁).

The query template of FIG. 11, however, shows little more than the existence of a single complement query for a sequence \vec{u} of updates. It is inefficient, even utilizing the two-pass algorithm given earlier for computing each Qᵤ_{ᵢ}^{c}. It requires 2k passes of the tree to process \vec{u}. Furthermore, to evaluate the XPATH expression in each uᵢ it conducts a separate bottom-up traversal of the entire tree.

2. Incremental Approach

FIG. 12 illustrates another algorithm, multiUpdate, that computes a complement query Q_{\vec{u}}^{c} for a sequence \vec{u}=u₁, . . . , uₖ of updates, which is built on incremental computation techniques. While the worst-case complexity of Q_{\vec{u}}^{c} is the same as that of the complement query of FIG. 11, it reduces unnecessary computation. Indeed, Q_{\vec{u}}^{c} needs k+1 passes of the tree rather than 2k passes, namely, a single bottom-up pass of the tree for evaluating qualifiers, followed by k passes to process updates. Each of the k passes, referred to as a sweep, processes an update in u and reevaluates qualifiers associated with only the parts of the tree that are affected by a previous update. Each pass/sweep enters and leaves each node at most once.

A. Multiple Updates

Assume that the X expression embedded in uᵢ is pᵢ, and that the input XML tree is T. The key idea of the algorithm multiUpdate is to (1) evaluate the qualifiers in all pᵢ's via a single bottom-up traversal of T; that is, the evaluation of all the qualifiers are combined and conduct it in a single pass of the tree; (2) process each update uᵢ for iε[1, K] via a top-down traversal of the tree; (3) when each uᵢ is performed, incrementally update the qualifiers of pⱼ for j>i rather than recomputing them starting from scratch. The incremental computation is conducted on only those nodes affected by the update uᵢ, i.e., either the new nodes inserted into T and/or certain nodes on a path from the root to the nodes inserted/deleted/renamed by uᵢ, instead of over the entire tree. The rationale is that uᵢ typically only incurs small changes to the tree and thus only the updated parts need to be checked. This motivates us to utilize incremental technique to minimize unnecessary recomputation of qualifiers in a sequence of XML updates.

FIG. 12 illustrates the algorithm multiUpdate. MultiUpdate takes as input a list \vec{u} of updates and an XML tree T, and returns as output the updated tree \vec{u}(T). It invokes a function combinedBU to compute the qualifiers in all the X expressions p₁, . . . , pₖ embedded in u via a single bottom-up traverse of T (line 2). To do this, it computes a list Q of all the distinct qualifiers in p₁, . . . , pₖ (line 1), which is passed to combinedBU as a parameter. To simplify the presentation, qualifiers of Q are evaluated at each node of T; however, filtering NFAs introduced above can be easily incorporated into combinedBU such that the qualifiers evaluated at a node n are only those that are necessary to check. Upon the completion of combinedBU, the algorithm processes each uᵢ in \vec{u} by invoking a function sweep (lines 3-10), which takes as input the selecting NFA Mₚ for pᵢ, among other things. The function sweep processes the update uᵢ and incrementally adjusts qualifiers in Pᵢ₊₁, . . . , pₖ associated with only those nodes affected by uᵢ.

B. Bottom Up Processing

Given a node n in an XML tree T, the function combinedBU evaluates the qualifiers of p₁, . . . , pₖ at n and its descendants, via a bottom-up traversal of the subtree rooted at n. It returns the annotated XML tree T′ in which each node n is associated with satₙ(q), rsatₙ(q) and rdsatₙ(q). The details are omitted, as it is a mild extension of the bottomUp function given in FIG. 9. Similar to bottomUp, one can verify that combinedBU takes at most O((|p₁|²+ . . . +|pₖ|²)|T|)time.

Note that combinedBU evaluates all the qualifiers in p₁, . . . , pₖ, in a single pass of T rather than k passes. Furthermore, common qualifiers in these XPATH expressions are evaluated only once.

Consider a sequence \vec{u}₀=u₁, u₂, u₃, where u₁, u₂, u₃ are the insert, delete and rename operations given in 1), 2) and 4) of the above example, directed to a supplier element, respectively. Given \vec{u}ₒ and the XML tree T₀ of FIG. 1, combinedBU evaluates all the qualifiers in \vec{u}ₒ in a single bottom-up pass of T₀. Moreover, the common qualifiers q₁, q₃, q₅, q₆, q₈, q₉ are evaluated only once for \vec{u}ₒ.

C. One Sweep: Combining Top-Down and Bottom-Up Processing

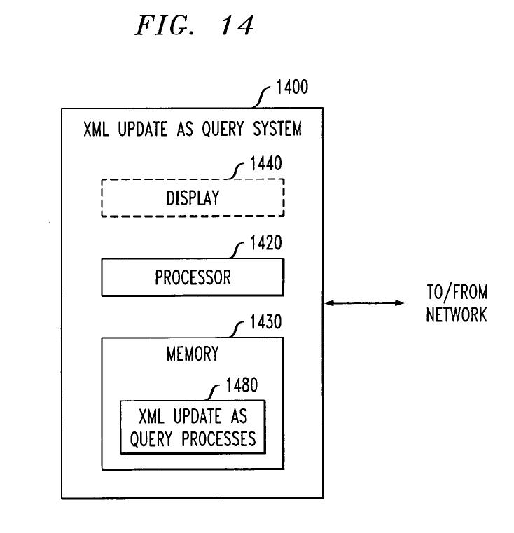

The function sweep, given in FIG. 13, processes an update \vec{u}ᵢ in u on a tree Tᵢ annotated with truth values of qualifiers in pᵢ, . . . , pₖ. Specifically, given us and a node n in Tᵢ, sweep does the following. (1) It processes the update uᵢ on the subtree ST rooted at n, and yields an updated subtree ST′ (2) In response to uᵢ, it incrementally evaluates the qualifiers of pᵢ₊₁, . . . , pₖ in order to ensure that for each node v in ST′ and each q of these qualifiers, satᵥ(q) accurately records whether or not q is satisfied at v in ST′.

The processing of uᵢ is conducted via a traversal of ST similar to the algorithm bottom Up of FIG. 9, using the selecting NFA Mₚ of pᵢ and the qualifiers of pᵢ evaluated earlier and associated with nodes of ST. The algorithm begins (lines 1-7) by recursively processing the right siblings of n to produce the list Ls, and retaining o, as the “old” right sibling (or ⊥ if there is none). At this point, any insert for n's parent, p(n), can be accomplished. If the current node has no right-sibling at line 4, then a check is made at line 5 to find out whether Mₚ was in the final state for an insert when p(n) was encountered. This is accomplished by checking S which still retains the current states of Mₚ for p(n). If an insert is to be performed for uᵢ, then the new subtree is computed (line 6) by evaluating the const-expr associated with uᵢ, the sat values in the newly inserted subtree are initialized by calling the function combinedBU, and the root of the subtree is returned as the right sibling. Otherwise an empty list is returned (line 7).

Once inserts and siblings have been handled, the set S′ of the Mₚ states reached at n is computed by calling the nextStates( ) function given in FIG. 4 (line 8). If Mₚ has reached the final state for a delete, it can now be accomplished by returning the sibling list at line 11. If uᵢ is a replace statement, the current node n is replaced by computing the new subtree in the same way as in the case for inserts. However, the computation at lines 26-28 needs to be performed to keep rsatₙ and rdsatₙ updated for the new node so a value cannot be immediately returned.

If either no final state is reached or a rename is required, S′ is checked to see if it is empty (line 14), in which case the children of n can be directly used without a call to sweep (line 15), effectively pruning the search space. Otherwise the children of n are processed recursively (line 17). The rename is handled right immediately after the recursive call (lines 19-22) by replacing n with a copy of n bearing the new label.

The qualifiers at n are re-evaluated (line 25) only if either renaming has taken place, or rsat or rdsat has changed at n's children (line 23). Moreover, sweep compares rsat and rdsat at oₛ (lines 2 and 4) and nₛ (line 26), the old and new right siblings respectively, to see if its rsat or rdsat is changed (line 27). The values rsat and rdsat are recomputed at n (line 28) along the same lines as bottomUp of FIG. 9, only if rsat or rdsat has changed at a child or at a right sibling of n. In this manner, sweep implements incremental processing of the changes in boolean values caused by uᵢ, and thus minimizes unnecessary calls to QualDP( ).

Finally, sweep returns a list in which the head is uᵢ (ST) with sat, rsat, rdsat incrementally evaluated, and the tail is the already-processed right-sibling list L, (lines 29-30).

Recall the updates \vec{u}ₒ=u₁, u₂, u₃ given in the above example. To handle \vec{u}ₒ over T₀ of FIG. 1, algorithm multiUpdate first invokes the function combined BU to process qualifiers in \vec{u}ₒ via a single pass of T₀. It then uses the function sweep to process u₁, u₂ and u₃ in turn. Observe that in the process of sweep for u₁, none of the qualifiers in u₂ and u₃ is changed at any existing node in T₀, and no incremental updates are needed since rsat and rdsat of those qualifiers are not changed at any node. Only the qualifiers in the newly inserted subtree are evaluated at this point. In the process of sweep for u₂, no incremental updates are done since there are no qualifiers to evaluate for u₃. Similarly, no incremental work is needed in sweep for u₃.

D. Complexity

Function sweep for update uᵢ, takes at most O(|uᵢ∥Tᵢ|+(|pᵢ₊₁|+ . . . |pₖ|)Tᵢ₊₁|) time. Hence, the data complexity of the algorithm multiUpdate is linear in the size of the trees. When the changes incurred by updates are small, as commonly found in practice, multiUpdate outperforms the complement-query of FIG. 11, since multiUpdate requires k+1 passes instead of 2k passes, and moreover, qualifier re-evaluation is only performed at nodes affected by previous updates rather than on the entire tree.

E. Discussion

Algorithms multiUpdate, combinedBU and sweep accommodate referential transparency and thus can be readily coded in XQUERY. These yield a single complement query QC in XQUERY with a linear-time data complexity for a sequence u. In addition, first, it minimizes unnecessary recomputation as just discussed. Second, the check of empty state set (line 14, sweep) avoids unnecessary processing of subtrees that are not affected by the update. Third, the incremental computation is combined with the process of the update uᵢ, instead of starting a separate bottom-up pass from scratch. Thus, the entire process of uᵢ is done in a single pass visiting each node at most once.

Given a sequence \vec{u}=u₁, . . . , uₖ, it is possible that an update uᵢ may cancel the effect of a previous update uⱼ(<i). For example, consider insert e into p followed by delete p′. If the XPATH expression p is contained in p′, i.e., any node reachable via p is also reachable via p′, then there is no need to execute the insert operation at all. This suggests that the containment problem for XPATH be considered, i.e., the problem to determine, given two XPATH expressions p and p′, whether or not for any XML tree T with root r, r∥p∥≦r∥p′∥. Unfortunately, the containment analysis may be impractical: it is EXPTIME-hard for X.

F. An Update Syntax for Defining Views

The ability to compute a complement query Q_{\vec{u}}^{c} from a sequence \vec{u} of updates suggests the following syntax for defining a view:
let $x=(Q,
   update u₁,
   . . . ,
   update uₙ
   )

Given an XML tree T, the value of $x is the tree computed by Q_{\vec{u}}^{c} (Q(T), where \vec{u}=u₁, . . . , uₙ. In terms of this update syntax one can define a security view from an integration view Q, as indicated above. In addition, this allows a seamless combination of queries and updates since $x can appear any place in a query where an XQUERY expression is allowed. Moreover, there are optimization techniques for combining the evaluation of Q with that of Q^{c}, as would be apparent to a person of ordinary skill.

FIG. 14 is a block diagram of a system 1400 that can implement the processes of the present invention. As shown in FIG. 14, memory 1430 configures the processor 1420 to implement the “XML query as update” methods, steps, and functions disclosed herein (collectively, shown as 1480 in FIG. 14). The memory 1430 could be distributed or local and the processor 1420 could be distributed or singular. The memory 1430 could be implemented as an electrical, magnetic or optical memory, or any combination of these or other types of storage devices. It should be noted that each distributed processor that makes up processor 1420 generally contains its own addressable memory space. It should also be noted that some or all of computer system 1400 can be incorporated into an application-specific or general-use integrated circuit.

System and Article of Manufacture Details

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention.

We claim:

1. A method for processing an update to an XML document, comprising:
converting said update into one or more complement queries that can be performed on said XML document.

2. The method of claim 1, further comprising the step of updating virtual views of XML data.

3. The method of claim 1, further comprising the step of composing updates and queries.

4. The method of claim 1, further comprising the step of processing said update to said XML document as a query performed on said XML document.

5. The method of claim 1, further comprising the steps of recursively processing down said XML document to determine for each node whether said node is affected by said update and implementing said update at said affected nodes.

6. The method of claim 1, wherein said method generates an updated version of said XML document.

7. The method of claim 1, further comprising the step of evaluating said one or more complement queries on said XML document to determine a set of nodes affected by said update.

8. The method of claim 1, wherein said converting step translates said update to a complement query without using a recursive function.

9. The method of claim 1, further comprising the step of processing an input as a finite state selecting automaton for each node to determine whether said node requires an update.

10. The method of claim 1, wherein said converting step further comprises the steps of a bottom up traversal of said XML document for evaluating qualifiers and a top down traversal for selecting nodes to be updated.

11. The method of claim 1, wherein said updates comprise a sequence of updates and wherein said converting step further comprises the step of processing said sequence of updates as a single complement query.

12. The method of claim 11, wherein said single complement query handles said sequence of updates based on incremental computation.

13. The method of claim 12, further comprising the step of computing all qualifiers in the sequence of updates via a single bottom-up process.

14. The method of claim 12, wherein after each update is processed, qualifiers in subsequent updates are incrementally evaluated by adjusting their values in response to any changes incurred by said update.

15. The method of claim 1, further comprising the step of processing an input as a finite state filtering automaton for each node to evaluate only those conditions that are needed later.

16. An apparatus for processing an update to an XML document, the apparatus comprising:
a memory; and
at least one processor, coupled to the memory, operative to:
convert said update into one or more complement queries that can be performed on said XML document.

17. The apparatus of claim 16, wherein said processor is further configured to update virtual views of XML data.

18. The apparatus of claim 16, wherein said processor is further configured to compose updates and queries.

19. The apparatus of claim 16, wherein said processor is further configured to process said update to said XML document as a query performed on said XML document.

20. An article of manufacture for processing an update to an XML document, comprising a machine readable medium containing one or more programs which when executed implement the step of:
converting said update into one or more complement queries that can be performed on said XML document.
